(19) United States
(12) Patent Application Publication
(10) Pub. No.: US 2025/0150964 A1
(43) Pub. Date: May 8, 2025

(54) WIRELESS ACCESS SCHEDULING DEVICE, WIRELESS ACCESS SYSTEM AND WIRELESS ACCESS SCHEDULING METHOD

(71) Applicant: Nippon Telegraph and Telephone Corporation, Tokyo (JP)

(72) Inventors: Kei FUJIMOTO, Musashino-shi, Tokyo (JP); Akinori SHIRAGA, Musashino-shi, Tokyo (JP); Ikuo OTANI, Musashino-shi, Tokyo (JP); Shogo SAITO, Musashino-shi, Tokyo (JP); Ko NATORI, Musashino-shi, Tokyo (JP)

(21) Appl. No.: 18/837,964

(22) PCT Filed: Feb. 24, 2022
(86) PCT No.: PCT/JP2022/007682

§ 371 Date: Aug. 13, 2024

(51) Int. Cl. H04W 52/02; H04W 72/0446; H04W 72/0453; H04W 72/12

(52) U.S. Cl. CPC H04W 52/0206; H04W 72/0446; H04W 72/0453; H04W 72/12

(57) ABSTRACT

A resource scheduling unit of a base station 100 assigns an RE multiplexed in a time domain and a frequency domain to each UE. The resource scheduling unit includes the following: a resource assignment calculation unit that performs scheduling of assigning a resource by assigning the resource to one side of a time axis in a case where traffic between the UE and the base station is equal to or less than a predetermined value; and a sleep control unit that distributes a scheduling result of the resource assignment calculation unit as resource assignment information or sleepable time information to each functional unit that is a part of the base station and is capable of sleeping.

### TECHNICAL FIELD

The present invention relates to a wireless access scheduling device, a wireless access system, and a wireless access scheduling method.

### BACKGROUND ART

In a wireless access system of mobile communication, a transmission timing of a radio signal between a terminal and a base station is achieved by assigning a resource element (RE) that is suitable for each terminal and is managed as a resource multiplexed in a time domain and a frequency domain by a medium access control (MAC) scheduler in the base station.

An overview of a wireless access system will be described.

FIG. 10 is a diagram describing an overview of a wireless access system.

As illustrated in FIG. 10, a wireless access system 1 includes a terminal (UE: user equipment) 10, an antenna (base station antenna) 20, a base station (BBU: base band unit) 30, and a core network 40.

The UE 10 includes a plurality of user equipment UE1, UE2, UE3, . . . , and UEn (n is any natural number), and the base station 30 assigns an RE (see hatching or shading pattern in FIG. 10; the hatching and shading patterns distinguish and represent REs) for each UE and manages the RE. When UE1, UE2, UE3, . . . , and UEn are collectively referred to, they are referred to as a UE 10.

The antenna 20 includes an antenna and a transceiver unit that wirelessly communicate with the UE 10 (hereinafter, the “antenna” collectively refers to an antenna, a transceiver unit, and a power supply unit thereof). Transmission/reception data is connected to the base station 30 by, for example, a dedicated cable.

The base station 30 is a fixed wireless station that is established on land and communicates with the UE 10. The base station 30 is dedicated hardware (a dedicated device) that performs wireless signal processing. Alternatively, the base station 30 is a virtual radio access network (vRAN) that performs wireless signal processing in a wireless access system of long term evolution (LTE) or five generation (5G) by a general-purpose server. In the vRAN (described later), a general-purpose server that is inexpensive and available in large quantities may be used as hardware of the base station 30.

The base station 30 includes hardware (HW) 31, an OS or the like 32, and a base station processing application 33.

The core network 40 is an evolved packet core (EPC)/(in the following description, “/” may denote “or”) a 5G Core Network (5GC) or the like.

vRAN

The vRAN will be described.

Since a wireless access system for mobile communication is required to have a high requirement regarding delay and a high throughput, a base station (BBU) that performs wireless signal processing has generally been supported by dedicated hardware (a dedicated device).

In recent years, with the spread and expansion of a general-purpose server (IA: Intel Architecture server [Intel: trademark]), the performance of the general-purpose server has been dramatically improved, and it has become possible to obtain the general-purpose server at low cost by mass production. As a result, vRAN in which a general-purpose server performs wireless signal processing of a BBU in an LTE or a 5G wireless access system has been studied.

In the vRAN, a general-purpose server that is inexpensive and available in large quantities may be used as hardware of the BBU, and thus, it is possible to construct a BBU pool by setting up a plurality of general-purpose servers in advance by setting up a server rack with a regional data center (DC) or a communication building within several 10 km from an antenna as an aggregation base (this concept may be referred to as centralized-RAN (C-RAN)).

With the BBU pool, a plurality of pieces of base station hardware (general-purpose servers) may be set up in advance. Thus, the BBU pool has a potential advantage of enabling flexible operation such as quick hardware replacement (switching) at the time of hardware failure and dynamic scale-out/in according to an increase or decrease in traffic.

FIG. 11 is a diagram describing an overview of resource scheduling at the base station 30 of the wireless access system 1 in FIG. 10.

As illustrated in FIG. 11, the base station 30 manages the transmission timing of a signal exchanged between the base station 30 and the UE 10 by assigning a resource multiplexed in the time domain (horizontal axis)×the frequency domain (vertical axis) to each UE 10.

The number of REs may be variously set depending on a division mode (numerology), a radio band, or the like. Furthermore, in order to enable efficient transmission, the base station measures a noise level or the like of a signal received from the UE, and performs control (for example, feedback loop control by hybrid automatic repeat request [HARQ]) such as assigning an RE suitable for each UE.

Patent Literature 1 defines a configuration of 5G mobile communication (3GPP specification [38.211]).

### CITATION LIST

### Non Patent Literature

Non Patent Literature 1: 5G FrameStructure, [online], [Searched on Feb. 11, 2022], the Internet <https://www.sharetechnote.com/html/5G/5G_FrameStructure.ht ml>

### SUMMARY OF INVENTION

### Technical Problem

In the related art, RE assignment for improving tolerance to noise due to radio wave interference and diffraction and RE assignment in consideration of service priority (QOS: quality of service) for each UE are achieved.

However, RE assignment control targeting power saving is not performed. Hereinafter, RE assignment control targeting power saving will be described.

FIG. 12 is a diagram describing a case where, in the wireless access system 1 of FIG. 11, the UE/base station/core network includes a function of achieving power saving by sleeping (stopping) while there is no data transmission/reception.

For example, in the UE 10 illustrated in FIG. 12, there is a request for stopping the UE when there is no data transmission/reception. Similarly, in the antenna 20 illustrated in FIG. 12, there is a request for stopping the antenna (turn off power of the antenna) when there is no data transmission/reception. Similarly, in the hardware 31 of the base station 30, there is a request for stopping the base station when there is no data transmission/reception. Similarly, in the core network 40, there is a request for stopping a node of the core network when there is no data transmission/reception. As described above, when the terminal/base station/core network is equipped with a function of achieving power saving by sleeping (stopping) while there is no data transmission/reception, it is desired to achieve power saving by maximally utilizing these functions. However, current RE assignment logic does not assume these.

FIG. 13 is a diagram describing an example of resource scheduling in the base station 30 of the wireless access system 1 of FIG. 10, and is an example of a case where RE assignment is performed without considering power saving when the amount of traffic is small.

As described above, the base station 30 manages the transmission timing of the signal exchanged between the base station 30 and the UE 10 by assigning a resource multiplexed in the time domain (horizontal axis)×the frequency domain (vertical axis) to each UE 10.

In the example of resource scheduling illustrated in FIG. 13, as can be seen in comparison with the example of resource scheduling illustrated in FIG. 11, a small amount of UE assignment occurs in any time slot, and there is UE assignment in any time slot. In FIG. 13, only one RE is UE assigned to each time slot. Therefore, a case is assumed in which the UE/base station/core network cannot sleep (stop).

As a conventional technology of achieving power saving, there is Discontinuous Reception (DRX) of an LTE specification defined by 3GPP. The DRX is a function of enabling a UE (terminal) to sleep while the UE (terminal) does not perform data communication. The UE needs to be powered on at all times so as to be able to respond to data (physical downlink control channel [PDCCH]) from the base station at any time even when there is no data communication. As a countermeasure, a timing (period) at which data arrives from the base station to the UE may be determined in advance by negotiation according to an agreement called the DRX, and the UE may be turned off (sleep) during a period other than the timing (period).

The DRX is intended to reduce power consumption of the UE and is not intended to save power of the base station itself or the core network. The DRX only determines in advance a timing (period) at which data arrives at the UE from the base station according to an agreement between the UE and the base station.

As described above, in the conventional wireless access system, RE assignment control targeting power saving is not currently performed at the base station.

The present invention has been made in view of such a background, and an object of the present invention is to secure a long power saving mode state by sleep and to enhance a power saving effect.

### Solution to Problem

In order to solve the above problem, there is provided a wireless access scheduling device of a base station that schedules a wireless access signal between a terminal and a base station, in which a resource element (RE) multiplexed in a time domain and a frequency domain is assigned to each of the terminal. The wireless access scheduling device includes the following: a resource assignment calculation unit that performs scheduling of assigning a resource by assigning the resource to one side of a time axis in a case where traffic between the terminal and the base station is equal to or less than a predetermined value; and a sleep control unit that distributes a scheduling result of the resource assignment calculation unit as resource assignment information or sleepable time information to each functional unit that is a part of the base station and is capable of sleeping.

### Advantageous Effects of Invention

According to the present invention, it is possible to secure a long power saving mode state by sleep and enhance a power saving effect.

### BRIEF DESCRIPTION OF DRAWINGS

FIG. 1 is a schematic configuration diagram of a wireless access system according to an embodiment of the present invention.

FIG. 2 is a diagram describing an example of resource scheduling in a base station of a wireless access system according to an embodiment of the present invention.

FIG. 3 is a flowchart illustrating wireless access scheduling processing by a resource scheduling unit of a base station of a wireless access system according to an embodiment of the present invention.

FIG. 4 is a diagram describing an example of resource scheduling in a case where an RE is to be newly assigned in a wireless access system according to an embodiment of the present invention.

FIG. 5 is a diagram describing an example of resource scheduling of optimization of an already assigned RE in a wireless access system according to an embodiment of the present invention.

FIG. 6 is a diagram describing a configuration example of a base station and antennas in a case where a plurality of antennas are accommodated in the base station of a wireless access system according to an embodiment of the present invention.

FIG. 7 is a diagram illustrating an RE assignment table included in the base station of FIG. 6.

FIG. 8 is an explanatory diagram in a case where the base station of FIG. 6 manages a plurality of antennas with one RE assignment table.

FIG. 9 is a hardware configuration diagram illustrating an example of a computer that implements functions of a wireless access scheduling device of a wireless access system according to an embodiment of the present invention.

FIG. 10 is a diagram describing an overview of a wireless access system.

FIG. 11 is a diagram describing an overview of resource scheduling in a base station of the wireless access system in FIG. 10.

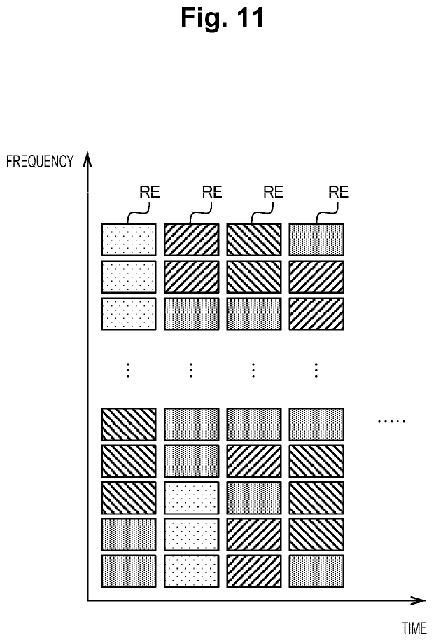

FIG. 12 is a diagram describing a case where, in the wireless access system of FIG. 11, the UE/base station/core network includes a function of achieving power saving by sleeping (stopping) while there is no data transmission/reception.

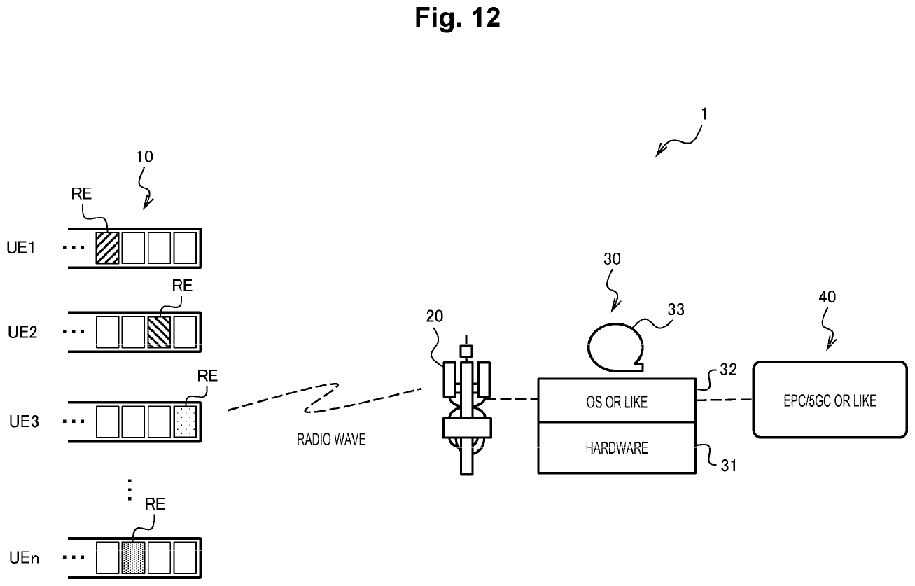

FIG. 13 is a diagram describing an example of resource scheduling in the base station of the wireless access system in FIG. 10.

### DESCRIPTION OF EMBODIMENTS

Hereinafter, a wireless access system and the like according to a mode for carrying out the present invention (hereinafter, referred to as “present embodiment”) will be described with reference to the drawings.

### Overview

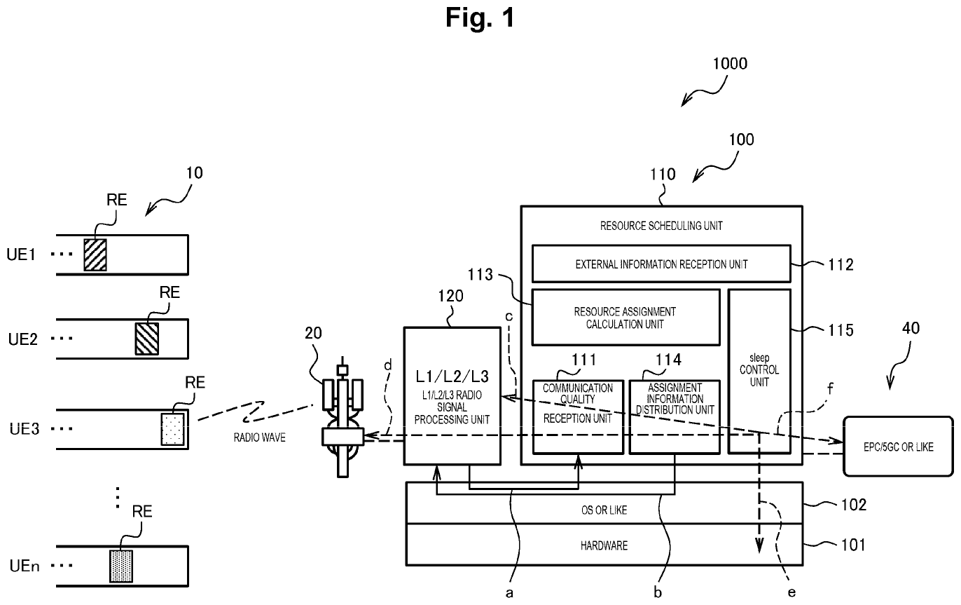

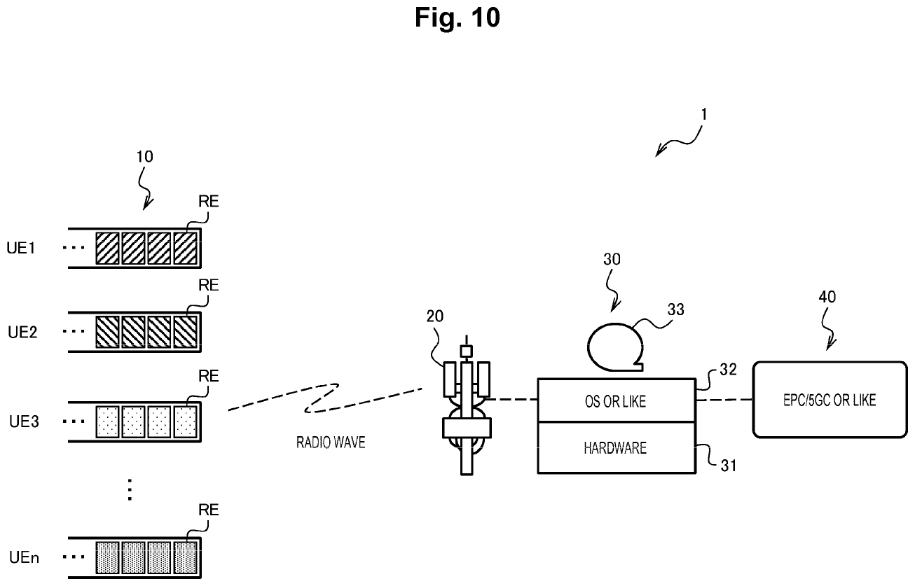

FIG. 1 is a schematic configuration diagram of a wireless access system according to an embodiment of the present invention. The present embodiment is applicable to a wireless access system of EPC/5GC mobile communication. The same components as those in FIG. 10 are denoted by the same reference signs.

As illustrated in FIG. 1, a wireless access system 1000 includes a terminal (UE) 10, an antenna 20, a base station (BBU) 100, and a core network 40.

The base station 100 includes hardware 101, an OS or the like 102, a resource scheduling unit 110 (wireless access scheduling device), and an L1/L2/L3 radio signal processing unit 120.

The resource scheduling unit 110 of the base station 100 is a wireless access scheduling device of the base station 100 that assigns an RE multiplexed in the time domain and the frequency domain for each UE 10 and schedules a wireless access signal between the UE 10 and the base station 100.

The resource scheduling unit 110 includes a communication quality reception unit 111, an external information reception unit 112, a resource assignment calculation unit 113, an assignment information distribution unit 114, and a sleep control unit 115.

The communication quality reception unit 111 receives wireless access communication quality information such as a channel quality indicator (CQI) (see an arrow a in FIG. 1) and transmits the wireless access communication quality information to the resource assignment calculation unit 113.

The external information reception unit 112 receives external information related to radio-access-network (RAN) resource assignment, such as QoS information or server resource information, and transmits the external information to the resource assignment calculation unit 113.

When traffic between the UE 10 and the base station 100 is equal to or less than a predetermined value (a setting value set in advance by an operator) (when a resource may be assigned to one side of the time axis), the resource assignment calculation unit 113 performs scheduling of assigning a resource by assigning the resource to one side of the time axis.

The resource assignment calculation unit 113 assigns a suitable resource to a target UE having a change. The resource assignment calculation unit 113 re-assigns an RE not only to a target UE having a change but also for an existing RE for which resource assignment from a MAC scheduler has already been completed.

The resource assignment calculation unit 113 periodically reviews an RE for which assignment has already been completed and reassigns the RE.

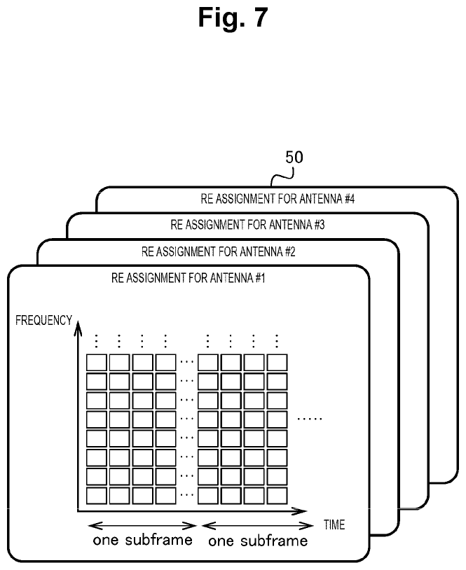

When a plurality of antennas 20 are connected to the base station 100, the resource assignment calculation unit 113 includes an RE assignment table 50 (see FIG. 7 to be described later) for each antenna 20. The RE assignment table 50 stores therein assignment information of REs for an antenna 20. The resource assignment calculation unit 113 assigns a resource to one side of a time axis for each antenna 20 by referring to the RE assignment table 50 (see FIG. 7 to be described later).

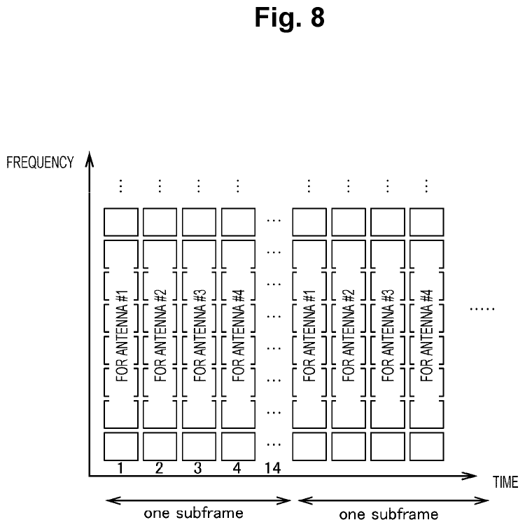

When a plurality of antennas 20 are connected to the base station 100, the resource assignment calculation unit 113 aggregates assignment in a time direction for each antenna and assigns a time slot to each antenna 20 (see FIG. 8 to be described later).

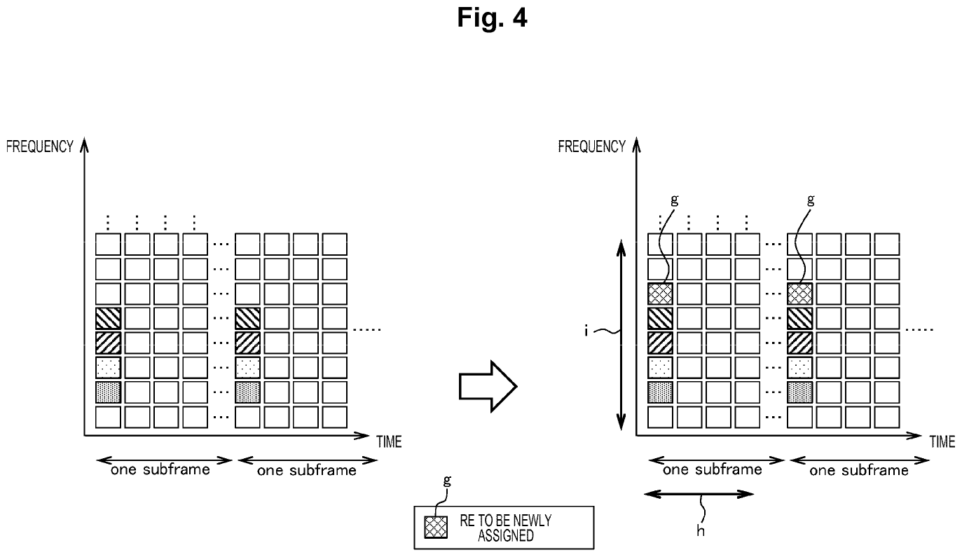

The resource assignment calculation unit 113 selects a time slot having a small noise content in wireless connection with the UE 10 and concentrates assignment on one side along a frequency axis so that REs do not spread across the frequency axis (see the right diagram of FIG. 4 to be described later).

The assignment information distribution unit 114 notifies the L1/L2/L3 radio signal processing unit 120 of resource assignment information of the target UE (see arrow b in FIG. 1).

The sleep control unit 115 distributes a result of the scheduling assigned by the resource assignment calculation unit 113 to each functional unit (the L1/L2/L3 radio signal processing unit 120, the hardware 101, the accelerator, the network device, the polling thread for high-speed data communication, or the like) that the base station 100 includes and is capable of sleeping as resource assignment information or sleepable time information.

In addition, the sleep control unit 115 delivers the resource assignment information or the sleepable time information to at least one of the UE 10, the antenna 20, or the core network 40, that is, to an external functional unit that is outside the base station, capable of sleeping, and connected to the base station 100. The antenna 20 is categorized as an external functional unit capable of sleeping, but may be categorized as a functional unit of the base station 100 capable of sleeping.

Specifically, the sleep control unit 115 distributes the resource assignment information or the sleepable time information to each functional unit capable of sleeping of the base station 100, that is, to the L1/L2/L3 radio signal processing unit 120 (see the dashed arrow c in FIG. 1) and to an accelerator, for example, of the hardware 101 (see the dashed arrow e in FIG. 1). In addition, the sleep control unit 115 distributes the information to an external functional unit that is outside the base station, capable of sleeping, and connected to the base station 100, that is, to the antenna 20 (see a broken arrow d in FIG. 1) and to the core network 40 (see a broken arrow f in FIG. 1).

Here, the resource assignment information described above is distributed to each functional unit of the base station 100, and the sleepable time information is delivered to an external functional unit (the UE 10, the antenna 20, the core network 40) that is outside the base station, capable of sleeping, and connected to the base station 100. However, the names “resource assignment information” and “sleepable time information” are for the purpose of convenience and may be the same name.

Here, in a case where a resource may be assigned to one side of the time axis, the resource assignment calculation unit 113 performs a calculation of assigning the resource to one side of the time axis, whereas the sleep control unit 115 actually distributes a result of assignment by the resource assignment calculation unit 113 to each functional unit of the base station 100 that is capable of sleeping and an external functional unit that is outside the base station, capable of sleeping, and connected to the base station 100 as resource assignment information or sleepable time information.

The L1/L2/L3 radio signal processing unit 120 is a protocol processing unit such as for PHY (processing such as modulation scheme, coding scheme, and antenna multiplexing), Medium Access Control (MAC), Radio Link Control (RLC), or Packet Data Convergence Protocol (PDCP). The L1/L2/L3 radio signal processing unit 120 performs, for example, protocol processing of L2/L3/L4 defined by the OSI reference model.

The communication quality reception unit 111 and the assignment information distribution unit 114, and the L1/L2/L3 radio signal processing unit 120 may communicate with each other using a memory space prepared by an OS or the like 102 (see reference signs a and b in FIG. 1) or may communicate with each other using a memory space uniquely managed by a user space usable by a user on a server including an OS (for example, a host OS).

An operation of the wireless access system 1000 configured as described above will be described below.

### Description of Principle

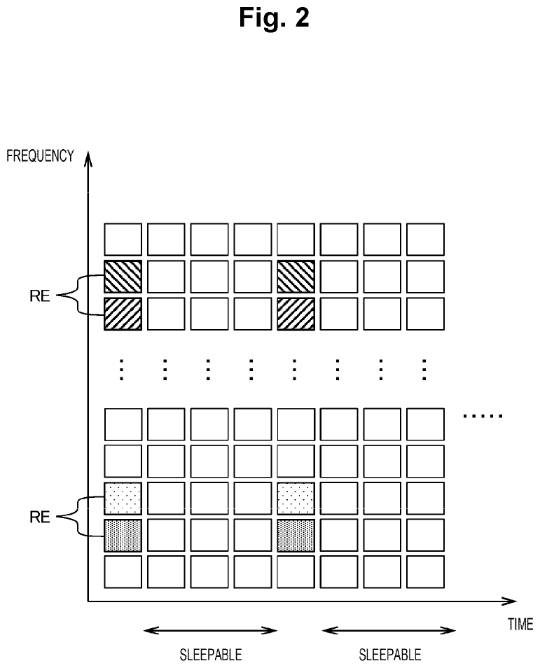

FIG. 2 is a diagram describing an example of resource scheduling at the base station 100 of the wireless access system 1000 of FIG. 1.

The base station 100 manages a transmission timing of a signal exchanged between the base station 100 and the UE 10 by assigning a resource multiplexed in the time domain (horizontal axis)×the frequency domain (vertical axis) to each UE 10.

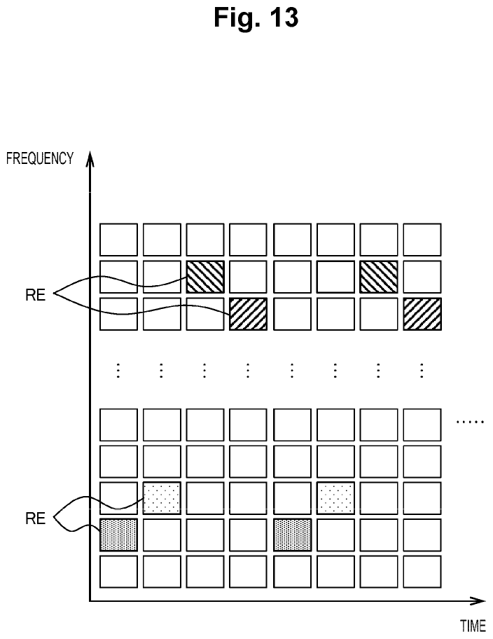

The resource scheduling unit 110 (wireless access scheduling device) concentrates resource assignment on one side of the time axis when traffic is small. As a result, each functional unit (the L1/L2/L3 radio signal processing unit 120, the hardware 101, the accelerator, the network device, the polling thread for high-speed data communication, or the like) of the base station and an external functional unit (the UE 10, the antenna 20, the core network 40, or the like) that is outside the base station and capable of sleeping may sleep for as long as possible. In the resource scheduling example of FIG. 2, resource assignment is concentrated on one side of the time axis for the resource scheduling example illustrated in FIG. 13 such that the sleepable time becomes long in each functional unit of the base station and in an external functional unit that is outside the base station and is capable of sleeping. By concentrating the resource assignment on one side of the time axis, a sleepable time may be generated in each of the functional units and the external functional unit as indicated by “SLEEPABLE” of the arrows in FIG. 2.

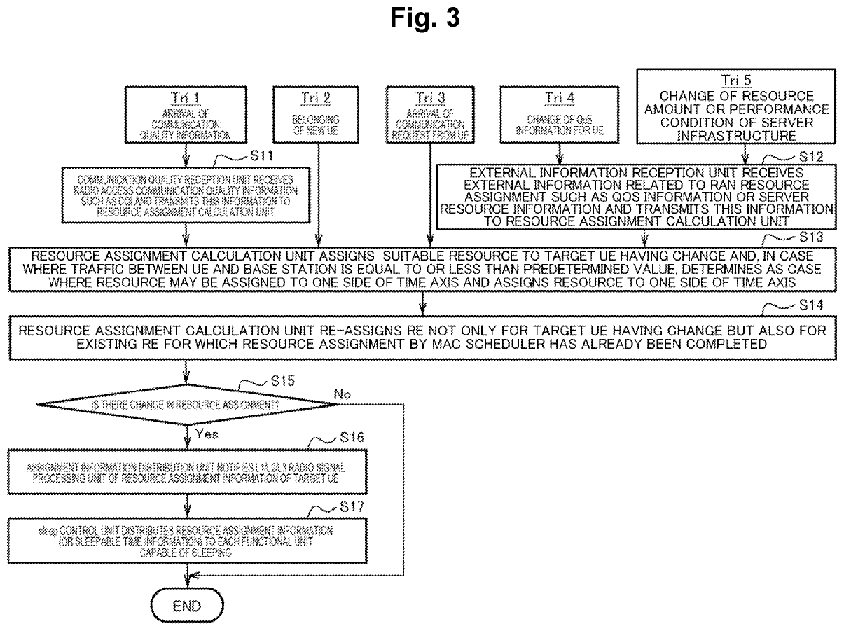

FIG. 3 is a flowchart illustrating wireless access scheduling processing by the resource scheduling unit 110 of the base station 100.

This process starts with one of the following triggers. That is, the process starts with arrival of activation communication quality information (Tri1), belonging of a new UE (Tri2), arrival of a communication request from a UE (Tri3), a change of quality of service (QOS) information for a UE (Tri4), or a change of a resource amount or a performance condition of a server infrastructure (Tri5), as a trigger. Here, a change of QoS information for a UE (Tri4) is acquired by reception from a RAN Intelligent Controller (RIC), a Service Management Orchestration (SMO), or the like. A change in a resource amount or a performance condition of a server infrastructure (Tri5) is, for example, a change in the number of available CPU cores.

With arrival of activation communication quality information (Tri1) as a trigger, in step S11, the communication quality reception unit 111 of the resource scheduling unit 110 receives wireless access communication quality information such as a channel quality indicator (CQI) and transmits the wireless access communication quality information to the resource assignment calculation unit 113 of the resource scheduling unit 110, and the process proceeds to step S13.

With belonging of a new UE (Tri2) or arrival of a communication request from a UE (Tri3) as a trigger, the process proceeds to step S13.

With arrival of a change of quality of service (QOS) information for a UE (Tri4) or a change of a resource amount or a performance condition of a server infrastructure (Tri5) as a trigger, the external information reception unit 112 of the resource scheduling unit 110 receives external information related to RAN (radio access network) resource assignment such as the QoS information or the server resource information in step S12, and transmits the external information to the resource assignment calculation unit 113, and the process proceeds to step S13.

In step S13, the resource assignment calculation unit 113 assigns a suitable resource to the target UE 10 that has undergone a change, and in a case where traffic between the UE 10 and the base station 100 is equal to or less than a predetermined value, determines that the resource may be assigned to one side of the time axis, and performs scheduling of assigning the resource to one side of the time axis. That is, in a case where a resource may be assigned to one side of the time axis, the resource assignment calculation unit 113 assigns the resource to one side of the time axis. For example, as illustrated in FIG. 2, resource assignment is performed by concentrating the assignment on one side of the time axis. By concentrating the resource assignment on one side of the time axis, a sleepable time may be generated in each of the functional units as indicated by “SLEEPABLE” of the arrows in FIG. 2.

In step S14, the resource assignment calculation unit 113 re-assigns an RE not only to a target UE having a change but also for an existing RE for which resource assignment by the MAC scheduler has already been completed. In addition, the resource assignment calculation unit 113 may reassign an RE when there is a prospect of extending a sleepable time or reducing the noise content of the radio signal.

In step S15, the resource assignment calculation unit 113 determines whether there is a change in resource assignment. When there is no change in the resource assignment (S15: No), the processing of this flow ends.

When there is a change in the resource assignment (S15: Yes), in step S16, the assignment information distribution unit 114 notifies the L1/L2/L3 radio signal processing unit 120 of the resource assignment information of the target UE (see reference sign c in FIG. 1).

In step S17, the sleep control unit 115 distributes the resource assignment information (or the sleepable time information) to each functional unit capable of sleeping and an external functional unit that is outside the base station and capable of sleeping. That is, the sleep control unit 115 distributes the resource assignment information to the antenna 20 (see reference sign d in FIG. 1), to, for example, an accelerator of the hardware 101 (see reference sign e in FIG. 1), and to the core network 40 (see reference sign f in FIG. 1). And the processing of this flow ends.

Further, the sleep control unit 115 may distribute the sleepable time information to each functional unit that the base station 100 includes and is capable of sleeping and an external functional unit that is outside the base station and is capable of sleeping, instruct to turn off power or transition to a sleep mode, and control each functional unit of the base station 100 and the external functional unit that is outside the base station and capable of sleeping.

### Example of Functional Unit Capable of Sleeping

An example of a functional unit (including an external functional unit) capable of sleeping will be described.

The functional units capable of sleeping include (1) the UE 10, (2) a transmission device, (3) the base station 100, and (4) the core network 40. The base station 100, which is listed above as item (3), includes (3-1) the L1/L2/L3 radio signal processing unit 120, (3-2) the accelerator, (3-3) the network device, and (3-4) the polling thread for high-speed data communication. Hereinafter, description will be made in order.

(1) UE10

Whether the UE has a sleepable function depends on a type thereof. Many terminals driven by a battery, such as a smartphone, is installed with a function of allowing a CPU or the like to sleep while there is no data communication.

(2) Transmission Device

There is a transmission device such as an L2 switch or a passive optical network (PON) that transitions to a power saving mode while there is no data communication to enhance a power saving effect.

(3) Base Station 100

(3-1) L1/L2/L3 Radio Signal Processing Unit 120

The L1/L2/L3 radio signal processing unit 120 may reduce CPU power consumption by sleeping and not using the CPU during a period in which there is no data communication.

(3-2) Accelerator

The CPU offloads processing to an accelerator such as a field-programmable gate array (FPGA), a graphics processing unit (GPU), an application-specific integrated circuit (ASIC) for encoding/decoding processing such as forward error correction (FEC) that may involve a large amount of parallel operation at the base station. During a period in which there is no data communication, power consumption of the accelerator may be reduced by enabling the accelerator to sleep.

(3-3) Network Device

The network device enables the network device such as a network interface card (NIC) to sleep during a period in which there is no data communication. This may reduce power consumption of the network device.

(3-4) Polling Thread for High-Speed Data Communication

The polling thread for high-speed data communication enables the polling thread for high-speed data communication to sleep during a period in which there is no data communication. This may reduce power consumption of the CPU.

(4) Core Network 40

A core network node is made to sleep during a period in which there is no data communication. As a result, there is a device that may expect power saving.

A period in which there is no data communication may be created by resource scheduling of the resource scheduling unit 110 (wireless access scheduling device). Therefore, with each functional unit that the base station includes and is capable of sleeping and an external functional unit that is outside the base station and is capable of sleeping, power saving effect may be enhanced further by transitioning to sleep or transitioning to a power saving mode.

Further, the sleep control unit 115 may cooperate with each functional unit that the base station includes and is capable of sleeping and with an external functional unit that is outside the base station and is capable of sleeping, and active sleep control may be performed by said each functional unit and said external functional unit receiving resource assignment information (or sleepable time information) of the sleep control unit 115.

### RE Assignment

RE assignment will be described.

### Example of Case Where RE is Newly Assigned to UE

FIG. 4 is a diagram describing an example of resource scheduling in a case where a new RE is assigned. The left diagram of FIG. 4 is an example of resource scheduling before assigning an RE to a UE. Reference sign g in FIG. 4 refers to an RE of the new UE that is to be assigned to the example of resource scheduling in the left diagram in FIG. 4. The right diagram in FIG. 4 is an example of resource scheduling after the new RE has been assigned.
Concentration on One Side of Time Axis

As indicated by reference sign h in the right diagram of FIG. 4, in one subframe, resource assignment is performed so that assignment is concentrated on one side of the time axis. Here, in the concentration on one side of the time axis, the RE of the new UE (see reference sign g in the right diagram of FIG. 4) is to be assigned as much as possible to a time slot to which another UE is already assigned (the time slot in the first column in one subframe). By assigning the RE of the new UE to the time slot to which another UE is already assigned, it is possible to obtain an effect of not shortening the sleepable time that has been secured by concentrating assignment on one side of the time axis.
Concentration on One Side of Frequency Axis

As indicated by reference sign i in the right diagram of FIG. 4, resource assignment may be performed so that assignment is concentrated on one side of the frequency axis in one subframe. Concentration on one side of the frequency axis includes the following characteristics.

That is, when a slot having a small noise content (high field intensity) in the wireless connection with the UE is selected, assignment is performed by concentrating assignment on one side of the frequency axis so that the REs do not spread across the frequency axis as much as possible. A frequency band to be used may be limited by concentrating assignment on one side of the frequency axis. As a result, a possibility of turning off a power supply of a circuit of the antenna for transmitting/receiving a radio wave may be increased.

As described above, an embodiment in which resource assignment is performed by concentrating resource assignment on one side of the frequency domain and not of the time axis is also possible. Further, concentrating resource assignment on one side of the time axis and concentrating resource assignment on one side in the frequency domain may be used in combination. The frequency transmitted from the antenna may be reduced by concentrating resource assignment on one side in the frequency domain, and power consumption of the antenna and the UE may be reduced.

### Example of Optimization of Already Assigned Existing RE

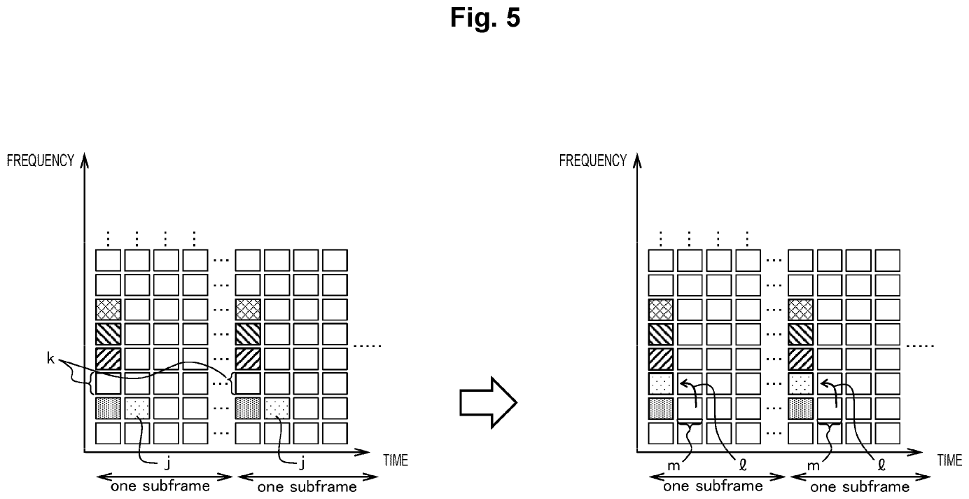

FIG. 5 is a diagram describing an example of resource scheduling of optimization of an already assigned existing RE. The left diagram in FIG. 5 illustrates an example of resource scheduling before optimization of an already assigned existing RE, and the right diagram in FIG. 5 illustrates an example of resource scheduling after optimization of an existing RE that had been assigned already.

In the case of mobile communication, since an RE moves between base stations, deletion of an RE that has moved and is no longer located or registration of a newly located RE is repeated.

In this process, as illustrated in the left diagram of FIG. 5, in one subframe, a time slot of the second column is also used due to RE exhaustion, and an RE is assigned to the time slot of the second column (see reference sign j in the left diagram of FIG. 5).

A situation may be assumed in which a time slot of the first column becomes available from an RE of the time slot of the first column being deleted (see reference sign k in the left diagram of FIG. 5).

An RE that has already been assigned (see reference sign j in the left diagram of FIG. 5) is periodically reviewed to optimize RE assignment. For example, as illustrated in the right diagram of FIG. 5, an RE (see reference sign j in the left diagram of FIG. 5) of a time slot of the second column is reassigned as indicated by an arrow 1 in the right diagram of FIG. 5 within one subframe, so that the time slot of the second column may be unfilled (see reference sign m in the right diagram of FIG. 5). As a result, there may be a case where sleepable time is expected to be prolonged.

### Example of Case Where a Plurality of Antennas are Accommodated in Base Station

RE Assignment Example (Case of Having RE Assignment Table for Each Antenna)

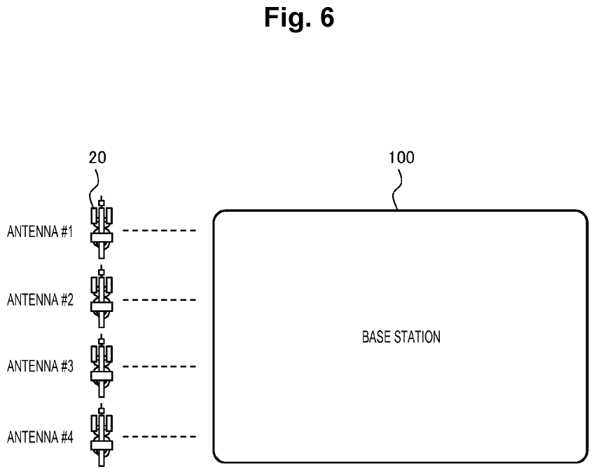

FIG. 6 is a diagram describing a configuration example of a base station 100 and antennas 20 in a case where a plurality of antennas are accommodated in the base station. FIG. 7 is a diagram illustrating an RE assignment table 50 (RE assignment storage unit) included in the base station 100 of FIG. 6.

As illustrated in FIG. 6, a plurality of antennas 20 (antennas #1 to #4) are connected to the base station 100, and the base station 100 holds the RE assignment table 50 (FIG. 7) for each of the antennas #1 to #4.

The resource scheduling unit 110 (FIG. 5) of the base station 100 uses the RE assignment table 50 (FIG. 7) for each of the antennas #1 to #4 to perform concentration of assignment on one side of the time axis as described with FIG. 4 for each of the antennas #1 to #4.
RE Assignment Example (Case Where a Plurality of Antennas Are Managed by One RE Assignment Table)

FIG. 8 is an explanatory diagram for a case where the base station 100 of FIG. 6 manages a plurality of antennas with one RE assignment table.

As a specific example of managing a plurality of antennas with one RE assignment table, there is a case where a fronthaul multiplexer (FHM) is used. The FHM distributes and combines radio signals on the fronthaul, for example, by up to 16.

In a case where a plurality of antennas are accommodated in one base station, FHM or the like is utilized, and management is performed with one RE assignment table, assignment is aggregated in the time direction for each antenna and a time slot is assigned to each antenna as illustrated in FIG. 8.

By aggregating the RE assignment in the time direction for each antenna, a sleepable time of the antenna may be extended. For example, in FIG. 8, since there is no RE assignment in times slots of the second to fourteenth columns for antenna #1, the antenna #1 may sleep during this period.

### Example of Same Time Slot Assignment in Units of Antennas

In the wireless access system 1000, it may be possible to separate base station functions into a radio unit (RU)/a distributed unit (DU)/a centralized unit (CU).

An accommodated user may be assigned to the same time slot in units of antennas (alternatively, in units of RUs in a vRAN system that is compliant with O-RAN [Open-RAN] in a case of a configuration in which an RU and a vDU are separated). This makes it possible to increase the time during which an antenna/RU may sleep when the antenna/RU includes a sleepable function.

### Hardware Configuration

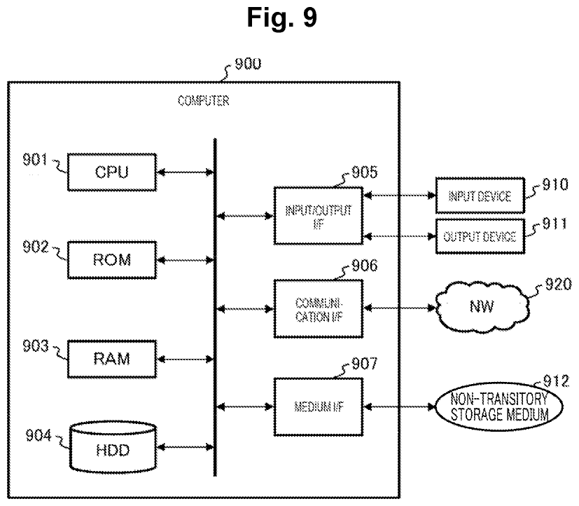

The resource scheduling unit 110 (wireless access scheduling device) according to the above embodiment is achieved for example by a computer 900 that is configured as illustrated in FIG. 9.

FIG. 9 is a hardware configuration diagram illustrating an example of a computer 900 that implements the functions of the resource scheduling unit 110.

The computer 900 includes a CPU 901, a ROM 902, a RAM 903, an HDD 904, a communication interface (I/F) 906, an input/output interface (I/F) 905, and a medium interface (I/F) 907.

The CPU 901 operates on the basis of a program stored in the ROM 902 or the HDD 904 and controls each unit of the resource scheduling unit 110 illustrated in FIG. 1. The ROM 902 stores therein a boot program that is executed by the CPU 901 when the computer 900 starts, a program that is dependent on hardware of the computer 900, or the like.

The CPU 901 controls an input device 910, such as a mouse or a keyboard, and an output device 911, such as a display, via the input/output I/F 905. The CPU 901 acquires data from the input device 910 and outputs generated data to the output device 911 via the input/output I/F 905. Note that a graphics processing unit (GPU) or the like may be used as a processor in conjunction with the CPU 901.

The HDD 904 stores a program to be executed by the CPU 901, data to be used by the program, or the like. The communication I/F 906 receives data from another device via a communication network (for example, network (NW) 920), outputs the data to the CPU 901, and transmits data generated by the CPU 901 to another device via the communication network.

The medium I/F 907 reads a program or data stored in a non-transitory storage medium 912, and outputs the program or data to the CPU 901 via the RAM 903. The CPU 901 loads a program related to target processing from the non-transitory storage medium 912 into the RAM 903 via the medium I/F 907 and executes the loaded program. The non-transitory storage medium 912 is an optical recording medium such as a digital versatile disc (DVD) or a phase change rewritable disk (PD), a magneto-optical recording medium such as a magneto-optical disk (MO), a magnetic recording medium, a conductor memory tape medium, a semiconductor memory, or the like.

For example, in a case where the computer 900 functions as the resource scheduling unit 110 configured as a device according to the present embodiment, the CPU 901 of the computer 900 implements the functions of the resource scheduling unit 110 by executing a program that is loaded into the RAM 903. Further, the HDD 904 stores therein data in the RAM 903. The CPU 901 loads a program related to a target processing from the non-transitory storage medium 912 and executes the program. Additionally, the CPU 901 may load a program related to a target processing from another device via the communication network (NW 920).

### Effects

As described above, a resource scheduling unit 110 of a base station 100 is a wireless access scheduling device of the base station 100 that schedules a wireless access signal between a UE 10 and the base station 100. The resource scheduling unit 110 assigns a resource element (RE) multiplexed in a time domain and a frequency domain to each UE 10. The resource scheduling unit 110 includes: a resource assignment calculation unit 113 that performs scheduling of assigning a resource by assigning the resource to one side of a time axis in a case where traffic between a terminal (UE 10) and the base station 100 is equal to or less than a predetermined value; and a sleep control unit 115 that distributes a scheduling result of the resource assignment calculation unit 113 as resource assignment information or sleepable time information to each functional unit that is a part of the base station 100 and is capable of sleeping.

By such a configuration, when the amount of traffic is small, scheduling is performed by concentrating resource assignment on one side of a time axis such that each functional unit that is a part of the base station 100 and is capable of sleeping (the L1/L2/L3 radio signal processing unit 120, the hardware 101, the accelerator, the network device, the polling thread for high-speed data communication, or the like) may sleep for as long a time as possible. As a result, it may be possible to create a period in which there is no data communication, and thus, it may be possible to expect power saving by sleep for a long time in each of the above-described functional units. That is, when the L1/L2/L3 radio signal processing unit 120, the hardware 101, the accelerator, the network device, the polling thread for high-speed data communication, or the like includes a function of transitioning to sleep or to a power saving mode while there is no data communication, it may be possible to secure the sleep/power-saving mode state for a long time according to the present invention, and thus, it may be possible to enhance the power saving effect.

Since the present invention is closed in the base station and may be implemented without modifying a terminal or a core network, the present invention is also advantageous in terms of cost. Since the terminal uses a wireless resource assigned by the MAC scheduler of the base station 100 in a subordinate manner, there is no need to perform reconstruction or the like on the terminal side.

In the wireless access system 1000, the sleep control unit 115 of the resource scheduling unit 110 (wireless access scheduling device) delivers the resource assignment information or the sleepable time information to an external functional unit that is at least one of the UE 10, the antenna 20, or the core network 40, the external functional unit being outside the base station, capable of sleeping, and connected to the base station 100.

By such a configuration, it is possible to create a period in which there is no data communication. Therefore, when an external functional unit (the UE 10, the antenna 20, the core network 40, or the like) that is outside the base station and is capable of sleeping includes a function of transitioning to sleep or to a power saving mode while there is no data communication, it may be possible to secure the sleep/power-saving-mode state for a long time. As a result, at the external functional unit that is outside the base station and is capable of sleeping, such as the UE 10, the antenna 20, the core network 40, or the like, the power-saving-mode state through sleep may be secured for a long time, and the power saving effect may be enhanced.

In the wireless access system 1000, the resource assignment calculation unit 113 of the resource scheduling unit 110 (wireless access scheduling device) periodically reviews an RE for which assignment has already been completed and reassigns the RE.

As a result, it may be possible to dynamically achieve appropriate resource assignment following a change in data communication request amount of the UE 10, a change in QoS, or a change in a resource amount of a server infrastructure.

In the wireless access system 1000, when a plurality of antennas 20 are connected to the base station 100, the resource assignment calculation unit 113 of the resource scheduling unit 110 (wireless access scheduling device) includes, for each antenna, an RE assignment storage unit that stores therein assignment information of REs, and assigns a resource for each antenna 20 by referring to the RE assignment storage unit and assigning the resource to one side of the time axis.

As a result, it may be possible to assign an optimal time slot for each antenna 20, secure a long power saving mode state by sleep, and further enhance the power saving effect.

In the wireless access system 1000, when a plurality of antennas 20 are connected to the base station 100, the resource assignment calculation unit 113 of the resource scheduling unit 110 (wireless access scheduling device) aggregates assignment in a time direction for each antenna and assigns a time slot to each antenna 20.

As a result, by aggregating RE assignment in a time direction for each antenna, the sleepable time of the antenna may be extended.

In the wireless access system 1000, the resource assignment calculation unit 113 of the resource scheduling unit 110 (wireless access scheduling device) selects a time slot having a small noise content in wireless connection with the UE 10 and concentrates assignment on one side of a frequency axis so that REs do not spread across the frequency axis.

As a result, by concentrating assignment on one side of the frequency axis, it may be possible to limit a frequency band to be used, and it may be possible to increase the possibility that a circuit of the antenna for transmitting/receiving a radio wave be turned off.

Among the processing described in the above embodiment, all or some of the processing described as those to be automatically performed may be manually performed, or all or some of the processing described as those to be manually performed may be automatically performed by a known method. Information including the processing procedures, the control procedures, the specific names, the various kinds of data, and the parameters mentioned above in the specification or shown in the drawings may be modified as desired unless otherwise specified.

Further, each of the components of each of the devices illustrated in the drawings is a functional concept, and is not required to be physically configured as illustrated. In other words, a specific form of distribution or integration of individual devices is not limited to the illustrated form, and all or part of the configuration may be functionally or physically distributed or integrated in any unit according to various loads, usage conditions, or the like.

Further, some or all of the component, functions, processing units, processing means, or the like described above may be implemented by hardware, for example, by designing them in an integrated circuit. The above-described components, functions, or the like may be implemented by software for interpreting and executing a program for causing a processor to implement the respective functions. Information such as a program, a table, or a file for implementing the respective functions may be held in a recording device such as a memory, a hard disk, or a solid state drive (SSD), or in a recording medium such as an integrated circuit (IC) card, a secure digital (SD) card, or an optical disc.

### REFERENCE SIGNS LIST

10 UE (terminal) (external functional unit that is outside the base station and is capable of sleeping)
20 Antenna (external functional unit that is outside the base station and is capable of sleeping)
40 Core network (external functional unit that is outside the base station and is capable of sleeping)
50 RE assignment table (RE assignment storage unit)

### 100 Base Station (BBU)

101 Hardware (functional unit that is a part of the base station and is capable of sleeping)
102 OS or the like
110 Resource scheduling unit (wireless access scheduling device)
120 L1/L2/L3 radio signal processing unit (functional unit that is a part of the base station and is capable of sleeping)
111 Communication quality reception unit
112 External information reception unit
113 Resource assignment calculation unit
114 Assignment information distribution unit
115 Sleep control unit
1000 Wireless access system

### #1, #2, #3, #4 Antenna

What is claimed is:

1. A wireless access scheduling device of a base station that schedules a wireless access signal between a terminal and a base station, wherein
the wireless access scheduling device comprises a processor and is configured to assign a resource element (RE) multiplexed in a time domain and a frequency domain to each of the terminal, and
the processor is configured to:
perform scheduling of assigning a resource by assigning the resource to one side of a time axis in a case where traffic between the terminal and the base station is equal to or less than a predetermined value; and
distributes distribute a scheduling result of assigning the resource as resource assignment information or sleepable time information to each functional unit that is a part of the base station and is capable of sleeping.

2. The wireless access scheduling device according to claim 1, wherein
the processor is configured to deliver the resource assignment information or the sleepable time information to an external functional unit that is at least one of the terminal, an antenna, or a core network, the external functional unit being outside the base station, capable of sleeping, and connected to the base station.

3. The wireless access scheduling device according to claim 1, wherein
the processor is configured to periodically review an RE for which assignment has already been completed and reassign the RE.

4. The wireless access scheduling device according to claim 1, wherein,
when a plurality of antennas are connected to the base station,
the wireless access scheduling device includes, for each antenna, an RE assignment storage unit that stores therein assignment information of the RE, and the processor is configured to assign a resource for each antenna by referring to the RE assignment storage unit and assigning the resource to one side of the time axis.

5. The wireless access scheduling device according to claim 1, wherein,
when a plurality of antennas are connected to the base station,
the processor is configured to aggregate assignment in a time direction for each antenna and assign a time slot to each antenna.

6. The wireless access scheduling device according to claim 1, wherein
the processor is configured to select a time slot having a small noise content in wireless connection with the terminal and concentrate assignment on one side of a frequency axis so that the REs do not spread across the frequency axis.

7. A wireless access system that schedules a wireless access signal between a terminal and a base station, wherein
the base station includes a wireless access scheduling device comprising a processor and is configured to assign a resource element (RE) multiplexed in a time domain and a frequency domain to each of the terminal, and
the processor is configured to:
perform scheduling of assigning a resource by assigning the resource to one side of a time axis in a case where traffic between the terminal and the base station is equal to or less than a predetermined value; and
distribute a scheduling result of assigning the resource as resource assignment information or sleepable time information to each functional unit that is a part of the base station and is capable of sleeping.

8. A wireless access scheduling method of a wireless access scheduling device of a base station that schedules a wireless access signal between a terminal and the base station, wherein
the wireless access scheduling device comprising a processor is configured to assign a resource element (RE) multiplexed in a time domain and a frequency domain to each of the terminal, and
the wireless access scheduling method includes:
performing scheduling of assigning a resource by assigning the resource to one side of a time axis in a case where traffic between the terminal and the base station is equal to or less than a predetermined value; and
distributing a scheduling result of assigning of the resource by assigning the resource to one side of the time axis to each functional unit that is a part of the base station and is capable of sleeping, as resource assignment information or sleepable time information.
